(19) United States
(12) Patent Application Publication
(10) Pub. No.: US 2013/0120571 A1
(43) Pub. Date: May 16, 2013

(54) SECURITY CAMERA AND METHOD FOR CONTROLLING AUTO-FOCUSING OF THE SAME

(71) Applicants: Byung-Yun Lee, Seongnam-si (KR); Sun Jun, Seoul (KR); Sang-Min Lee, Goyang-si (KR); Pyoung-Hwa Choi, Pyeongtaek-si (KR); Ho Baek, Suwon-si (KR)

(72) Inventors: Byung-Yun Lee, Seongnam-si (KR); Sun Jun, Seoul (KR); Sang-Min Lee, Goyang-si (KR); Pyoung-Hwa Choi, Pyeongtaek-si (KR); Ho Baek, Suwon-si (KR)

(73) Assignee: ITX Security Co., Ltd., Seoul (KR)

(21) Appl. No.: 13/676,275

(22) Filed: Nov. 14, 2012

(30) Foreign Application Priority Data
Nov. 14, 2011 (KR) 10-2011-0118452

(51) Int. Cl. H04N 7/18

(52) U.S. Cl. CPC H04N 7/18
USPC 348/143

(57) ABSTRACT

A security camera and a method of controlling auto-focusing of the security camera. The security camera continuously performs auto-focusing during a period of time, from the time of power-on and the start of a boot sequence until the time of completion of the camera installation, and stops the auto-focusing thereafter. Accordingly, it is possible to improve the durability of a camera mechanical system and to achieve easy installation and manipulation of the camera.

### CROSS-REFERENCE TO RELATED APPLICATION(S)

This application claims the benefit under 35 U.S.C. §119(a) of Korean Patent Application No. 10-2011-0118452, filed on Nov. 14, 2011, in the Korean Intellectual Property Office, the entire disclosure of which is incorporated herein by reference for all purposes.

### BACKGROUND

1. Field

The following description relates to a security camera, and more particularly, to an auto-focusing technology.

2. Description of the Related Art

Auto-focusing function of a security camera is regarded as one of main causes to shorten the lifespan of the camera. A full-auto-focusing-type camera performs auto-focusing each time a distance to an object changes. An auto-focusing operation is carried out by adjusting distances between lenses while moving one of the lenses in a camera module using, for example, a voice coil motor. Frequent auto-focusing operations may lead to mechanical components of an operating part wearing out and consequently the lifespan of the camera may be shortened by several months.

A one-push auto-focusing-type camera, which is widely used for low-priced security cameras, is controlled by a connected computer to execute a one-push auto-focus operation once the camera is installed. By using the one-push auto-focusing-type camera, it becomes feasible to improve the durability of the camera since the auto-focusing is performed once only when the camera is newly installed. However, it is inconvenient that the camera is required to be connected to a computer for control and manipulation.

Korean Registration Patent No. 358,859 registered on Oct. 16, 2002, filed by CNB Technology Inc., discloses auto-focusing techniques of a security camera installed at a fixed location. The related art discloses that the security camera detects a focus state of the camera in a manual focus mode and performs auto-focusing only when the camera remains out of focus for longer than a predetermined period of time. Accordingly, it is possible to prevent deterioration of reliability of a motor or damage of a driving portion due to continuous auto-focusing control and to achieve enhanced camera image quality.

However, according to the related art, the security camera fixed at one location unnecessarily performs image processing to monitor the focus state even when a lens of the camera is in focus on one object, and thereby power consumption may be increased.

### SUMMARY

The following description relates to a method for controlling auto-focusing of a security camera which is capable of increasing the durability of an auto-focusing mechanical system and providing a user with easy installation and manipulation of the camera.

In addition, the following description also relates to a security camera having an auto-focusing function which is capable of reducing a load on a processor, thereby reducing costs and power consumption.

In one general aspect, there is provided a security camera including: an initial auto-focusing (AF) setting unit configured to continuously perform auto-focusing during a predetermined period of time, from a time of power on and start of a boot sequence until a time of completion of installation of the security camera, and stop the auto-focusing after the completion of installation.

The security camera may additionally perform auto-focusing when a pan-tilt operation is driven in response to the occurrence of an event, and stop the auto-focusing thereafter.

Other features and aspects may be apparent from the following detailed description, the drawings, and the claims.

### BRIEF DESCRIPTION OF THE DRAWINGS

FIG. 1 is a block diagram of a security camera according to an exemplary embodiment of the present invention.

FIG. 2 is a diagram for explaining an operation of a security camera according to an exemplary embodiment of the present invention.

FIG. 3 is a diagram for explaining another operation of a security camera according to an exemplary embodiment of the present invention.

FIG. 4 is a flowchart illustrating a method for controlling auto-focusing of a security camera according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

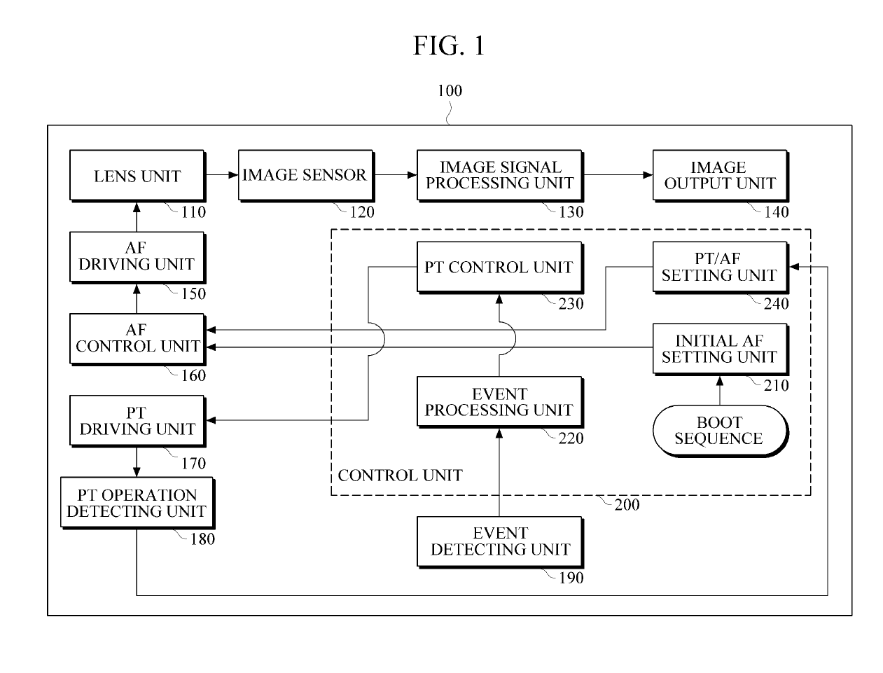

FIG. 1 is a block diagram of a security camera according to an exemplary embodiment of the present invention. As shown in FIG. 1, the security camera 100 may include a lens unit 110, an image sensor 120, an image signal processing unit 130, and an image output unit 140.

The lens unit 110, as an optical device for focusing on an object, may include one lens or a series of lenses. To bring an object through the lens into focus, a motor that drives a focus lens is stopped when high-pass filtering integral data provided by the image signal processing unit 130 reaches a peak value while the motor is moved from far focus point to a near focus point. The image sensor 120 converts an incoming optical signal of an object into a photoelectric signal and outputs a final analog image signal. The image sensor 120 may photoelectrically convert an optical image of the object to generate an image signal (an image charge), and provide the generated image signal to the image signal processing unit 130 using a raster scanning method. For example, the image sensor 120 may be of charge-coupled device (CCD) type or complementary metal oxide semiconductor (CMOS) type.

The image signal processing unit 130 may perform noise filtering and sampling on image data (image signal) output from the image sensor, and perform subsequent image signal processing, for example, gamma correction, color filter array interpolation, color matrix, color correction, and color enhancement, on the resulting image data for image quality enhancement. In addition, the image signal processing unit 130 may generate an image file by compressing the generated image data. For example, the image signal processing unit 130 may convert the image data into a format such as JPET or JPEG 2000.

In another example, the image data may be input in real time to the image signal processing unit 130, or, if necessary, may be temporally stored in a memory (not shown) and then provided to the image signal processing unit. The image output unit 140 may display image data on which the image signal processing unit 130 has performed the signal processing, allowing the user to view the image data. The image output unit 140 may be an external monitor connected to the image signal processing unit 130 to display the image data. For example, the image output unit 140 may be a display device such as a liquid crystal display (LCD), an organic light emitting diode (OLED), an active matrix light organic emitting diode (AMOLED), a plasma display panel (PDP), an embedded data display (EDD), and the like.

In another example, the security camera 100 may further include an auto-focusing (AF) driving unit 150, an AF control unit 160. The AF driving unit 150 may drive an AF operation, and adjust a position of the lens unit 110 via an actuator. For example, the actuator may be a voice coil motor (VCM). The AF control unit 160 may control the AF driving unit 150 to perform auto-focusing based on a focus evaluation value obtained according to a distance from and a position of the object image. The AF function may be performed when the image signal processing unit 130 processes and recognizes the image input through the image sensor 120.

In another example, the security camera 100 may further include an initial AF setting unit 210. The initial AF setting unit 210 may constantly perform auto-focusing during a predetermined period of time taken to install a camera module since the start of a boot sequence upon power-up, and stop the auto-focusing after the predetermined period of time. The initial AF setting unit 210 may provide an initial AF setting signal to the AF control unit 160, and the AF control unit 160 may provide an AF control signal to the AF driving unit 150 to move the position of the lens unit 110 into focus.

Accordingly, auto-focusing is automatically performed during a period of time from the time of power-on and the start of a boot sequence execution until the completion of the camera module installation and the auto-focusing automatically stops after the completion of the installation, so that easy and simple installation can be achieved and durability degradation due to the frequent auto-focusing can be prevented.

In another example, in response to power-on, power is supplied to the camera to perform a series of operations. The camera module installation time may be set to, for example, one hour. The boot sequence refers to a series of system initialization commands being executed during boot process.

In another example, the security camera 100 may further include a pan-tilt (PT) driving unit 170, and a PT operation detecting unit 180. The PT driving unit 170 may rotate the security camera 100 with respect to an object of an event in response to a PT control signal from the PT control unit 230. The PT driving unit may include an actuator. The PT operation detecting unit 180 may detect a pan-tilt (PT) operation, and provide a resulting detection signal to a PT/AF setting unit 240.

In another example, the security camera 100 may further include a control unit 200. The control unit 200 may provide control signals for auto-focusing and pan-tilt operation, and perform event pre-processing and boot process. Referring to FIG. 1, the control unit 200 may include an event processing unit 220, the PT control unit 230, and the PT/AF setting unit 240.

The event processing unit 220 may perform signal-processing, such as amplification, noise filtering, and analog-to-digital conversion, on an electric signals output from the event detecting unit 190, and provide the processed signals to the PT control unit 230. By receiving an event signal from the event processing unit 220, the PT control unit 230 may provide the PT control signal to the PT driving unit 170. The PT/AF setting unit 240 may receive a PT detecting signal from the PT operation detecting unit 230 and provide an AF setting signal to the AF setting unit 160 for additional AF in response to a change in position of the object. Upon detecting the PT operation, additional auto-focusing may be performed with respect to the object.

The series of operation commands may be stored in flash memory.

In another example, the security camera 100 may further include a detecting unit 220. The event detecting unit 190 may detect physical changes, such as changes in motion, sound, heat and/or light of the object, convert the change into an electric signal and provide the electric signal as a detection signals to the event processing unit 220.

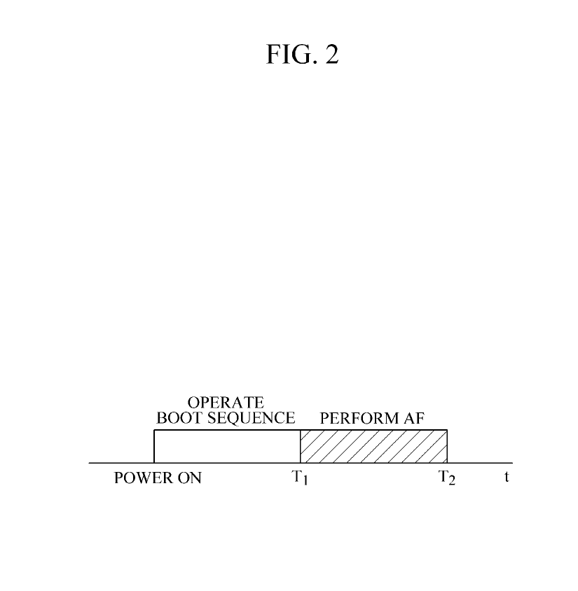

FIG. 2 is a diagram for explaining an operation of a security camera according to an exemplary embodiment of the present invention. As shown in FIG. 2, the security camera may perform auto-focusing during a certain period of time T2-T1, from the time of completion of a boot sequence operation until the time of completion of camera installation, and stop auto-focusing thereafter.

In another example, the installation time of the security camera is generally one hour, and thus the time T2-T1 may be previously set as 1 hour, or set arbitrarily using a timer included in the security camera.

Auto-focusing may be additionally performed upon the occurrence of a particular event after the installation of the camera. For example, the security camera may include an audio sensor and perform an additional auto-focusing operation one time in response to a clapping sound. In another example, the security camera may include a brightness sensor positioned around a camera lens and have a power-on function which is activated when the brightness sensor detects the brightness level around the camera lens as being lowered because the camera lens is shaded.

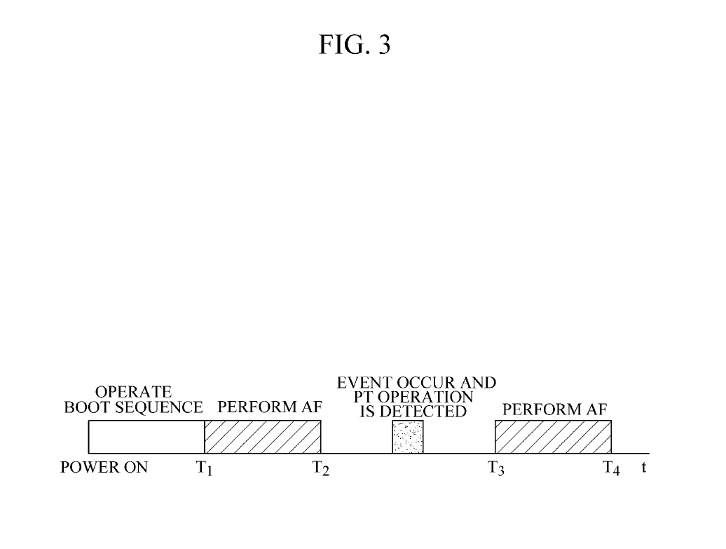

FIG. 3 is a diagram for explaining another operation of a security camera according to an exemplary embodiment of the present invention. As shown in FIG. 3, the security camera may perform auto-focusing during a certain period of time T2-T1 corresponding to a time taken to install a camera module, and thereafter perform further auto-focusing for a predefined period of time T4-T3 after an pan-tilt (PT) operation in response to the occurrence of an event is detected.

In another example, the predefined time T4-T3 may be a period of time that is generally required to perform auto-focusing after the detection of the PT operation. Examples of the event may include motions of the object, such as door opening/closing motions, human or animal motions, and movement of vehicles, the resulting sound of the motion, door-bell sound, ringtone, brightness of light, colors, and the like.

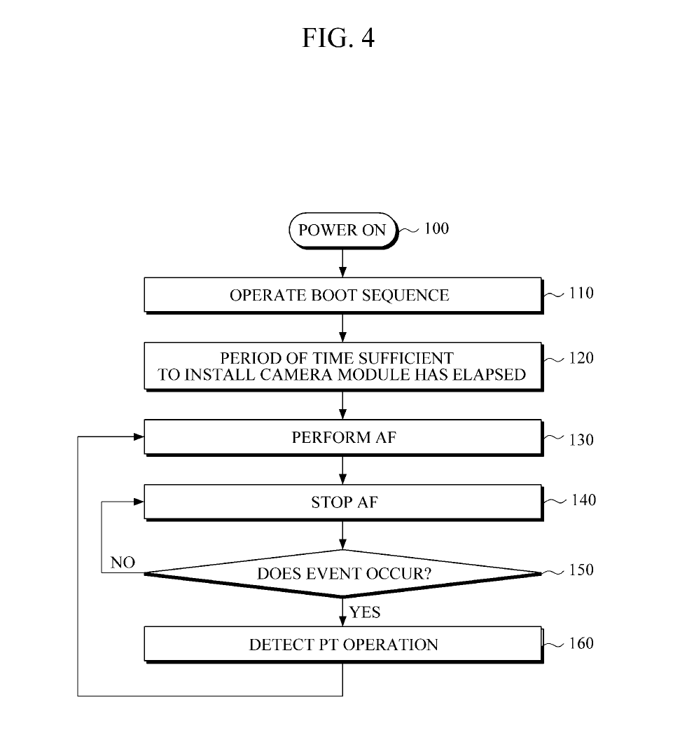

FIG. 4 is a flowchart illustrating a method for controlling auto-focusing of a security camera according to an exemplary embodiment of the present invention. As shown in FIG. 4, upon power on in 100, a boot sequence operates in 110, and after a predetermined period of time sufficient to install a camera module has elapsed in 120, auto-focusing is performed in 130. Thereafter, the auto-focusing is stopped in 140.

In another example, if a pan-tilt (PT) operation is detected in 160 in response to an event occurring thereafter in 150, the auto-focusing is continuously performed in 130, and then is stopped in 140.

As described above, it is possible to easily manipulate or install the security camera, and to increase the durability of a camera mechanical system and thus to prevent the reduction in lifetime of the camera which is caused by damage or wearing-out from the frequent auto-focusing.

Additionally, while the security camera is initially installed in a fixed position, auto-focusing is performed, and thereby the camera lens is automatically brought into focus, without the user's manipulation, by the time of completion of installation. Thus, the above-described security camera may be suitable to security devices that have been recently widely manufactured and used by general users, as non-experts, who look for easy installation.

The security camera may change a shooting range according to a location at which an event takes place. At this time, a distance to an object of the event may be changed. Furthermore, it is possible to efficiently improve image quality of the security camera without continuously monitoring focusing states, and to enhance the durability of the camera.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A security camera comprising:
an initial auto-focusing (AF) setting unit configured to continuously perform auto-focusing during a predetermined period of time, from a time of power on and start of a boot sequence until a time of completion of installation of the security camera, and stop the auto-focusing after the completion of installation.

2. The security camera of claim 1, further comprising:
a pan-tilt (PT)/auto-focusing (AF) setting unit configured to perform further auto-focusing in response to an PT operation.

3. The security camera of claim 1, additionally performing auto-focusing in response to a clapping sound and stopping the auto-focusing thereafter.

4. A method for controlling auto-focusing of a security camera, the method comprising:
executing a boot sequence upon power-on; and
performing auto-focusing for a predetermined period of time for which the security camera is installed and stopping the auto-focusing after the installation is completed.

5. The method of claim 4, further comprising:
detecting a pan-tilt operation; and
performing auto-focusing in response to the detected pan-tilt operation and stopping the auto-focusing thereafter.
